(19) United States
(12) Patent Application Publication
(10) Pub. No.: US 2008/0273936 A1
(43) Pub. Date: Nov. 6, 2008

(54) Method for Producing Rotationally Symmetrical, undercut Contours

(76) Inventors: Ralph Bernhardt, Ennepetal (DE); Matthias Prussak, Mulheim an der Ruhr (DE)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 11/721,699

(22) PCT Filed: Dec. 5, 2005
(86) PCT No.: PCT/EP05/12995

§ 371 Date: Nov. 14, 2007

(51) Int. Cl. B23C 3/00; F16J 9/00

(52) U.S. Cl. 409/132; 92/245

(57) ABSTRACT

The invention relates to a method for producing essentially rotationally symmetrical, undercut contours on workpieces (13) that can for example be produced by forging or casting, said workpieces having at least one sub-section (14) to be machined with an essentially symmetrical initial contour. The workpiece (13) is braced by the end that is not to be machined in a recess (11) and when in said recess (11) the sub-section (14) of the workpiece that is to be machined is placed against a tool (12). The tool (12) rotates with a constant or variable speed in relation to the sub-section (14) of the workpiece (13) that is to be machined. An undercut contour is thus produced on the sub-section (14) of the workpiece (13) by machining under the axial pressure.

### FIELD OF THE INVENTION

The present invention relates to a method for the chipless, non-cutting production of substantially rotationally symmetrical, undercut contours on a workpiece, as well as to a workpiece manufactured by means of this method. Undercut contours of this kind can be formed in particular on sub-sections of workpieces manufactured by forging, casting or cutting production.

### PRIOR ART

With the methods hitherto known from the prior art, rotationally symmetrical, undercut contours such as, for example, cooling ducts on pistons for commercial vehicle diesel engines are manufactured by means of cutting. That is, a starting workpiece manufactured, for example, by forging or casting, is machined by a material-removing method such as, turning, milling or cutting to produce an undercut contour.

The drawbacks of the known methods are, on the one hand, the high degree of chipping, particularly in the case of the inside contours of mass-produced goods such as, pistons, which need to be machined in their entirety, and, on the other hand, the associated grain interruption in the conventionally fabricated product. Such an interruption leads to structurally weaker workpieces, and thus adversely affects wear resistance, lifetime and costs of the final product.

### SUMMARY OF THE INVENTION

It is an object of the present invention to develop a method for the production of substantially rotationally symmetrical, undercut contours, which enables simpler and thus quicker and less expensive working.

This object is solved by a method having the features of claim 1. Advantageous embodiments are defined in the dependent.

A workpiece to be processed using said method comprises at least one sub-section to be worked having a substantially symmetrical, preferably rotationally symmetrical, initial contour such as a polygonal, cylindrical or right circular cone-shaped shaft, and an axis of rotation about which the workpiece can be rotated during processing. The sub-section to be worked of the workpiece can be designed to be in either solid, partly solid or hollow form. According to the method of the invention, the workpiece is first clamped into a collet at a first end portion not to be worked for example by positive locking and/or friction locking. The workpiece can then be moved with the collet towards a tool and relative thereto. Subsequently, the tool, which rotates with constant or variable speed about a center axis relative to the workpiece, is abutted against a substantially symmetrical, preferably rotationally symmetrical, second end portion to be worked of the workpiece. It is thus possible in the working step to chiplessly produce undercut contours such as cooling ducts on a piston while the tool applies axial pressure to the second end portion.

Furthermore, with the method according to the invention, undercut contours can readily be given the machining dimensions such that only a final mechanical fine-machining process is required to obtain the final product. As a result, manufacturing is quicker and thus less expensive.

Preferably, the movement of workpiece and tool towards each other, which is associated with the working step, is a feed motion which provides the axial pressure required for working. This feed motion can be carried out by the workpiece and collet, by the tool or by a parallel feed motion.

Advantages as compared to the above-described conventional methods result from the fact that in the working step according to the invention, material is not milled or cut off or removed in any other way, whereby continuous and uninterrupted grains are created in the material that extend substantially parallel to the formed undercut contour. This significantly increases material strength and lifetime of the finished product. Likewise, possible flaws in the final product are further reduced by the complete working the processed workpiece section.

According to a preferred embodiment, the undercut contour which is to be formed in the working step can be orientated inwardly or outwardly in a rotationally symmetrical manner with respect to the initial contour of the workpiece sub-section to be worked. Inner and/or outer cooling ducts of diesel engine pistons, which have to date been produced by chipping milling, can be cited herein as specific examples of inwardly or outwardly orientated contours. Outwardly orientated undercut contours can, for example, also be found on front axle housings which have to date likewise been produced by chipping machining. The method according to the invention makes it possible to produce both types of contours in a structurally stabler manner.

The tool used in the method according to the invention can have a symmetrical or asymmetrical tool contour, depending on the workpiece to be processed. Furthermore, it has proven to be advantageous for the tool to rotate with a first speed and for the workpiece to rotate with a second speed that can be selected to be different from the first speed. The speed of the tool may differ from that of the workpiece by up to 30%. If the drive system of the tool and/or of the collet additionally has a freewheel, the first and/or second speed can be altered. This leads to an extraordinarily regular flow of material with consequently improved properties of the final product.

For applications in which it is desired for the friction surface, located between the substantially symmetrical sub-section to be worked of the workpiece and the tool, to be kept large, the axis of rotation of the sub-section to be worked and the center axis of the tool may be aligned. If, however, lower friction, i.e. a smaller friction surface, is desired, as in the case of, for example, workpieces in which the sub-section to be worked is solid, the axis of rotation of the sub-section to be worked and the center axis of the tool may deviate, according to a further preferred embodiment, by an amount of eccentricity e. The amount of eccentricity can be adjusted in that the rotating tool rotates in an axially oscillating manner about the center axis of the workpiece section to be worked. This axial oscillation is achieved, for example, by way of a radial feed motion of the tool. The reduction of the friction surface moreover offers the advantage of requiring less force and thus less energy for working since there is only partial contact.

According to a further advantageous embodiment, the entire workpiece is subjected to the method with a temperature distribution that is determined based on preliminary processes, or is heated in a step preceding the method, for example to a forging temperature appropriate for the material. As a result, the flow stress (yield strength) of the material is lowered, and working of the rotationally symmetrical workpiece sub-section is facilitated.

It is particularly preferred for the geometry of the undercut to be adjusted in that the sub-section to be worked has a defined temperature distribution as a result of, for example, targeted heating in a preceding step. The geometry thereby comprises in particular the length of the formed undercut as well as its clearance. Due to this method feature, working is, on the one hand, simplified (lower flow stress) and, on the other hand, rendered more precise and reproducible.

The method according to the invention furthermore makes it possible to determine the exact shape of the undercut outer contour. To this end, the undercut outer contour, which is to be produced in the working step, is defined by pressing on one or more loose or driven tools. This pressing on can be effected in a substantially radial direction against the undercut being formed. The application of an additional tool, such as, for example, a pivotable tool equally serves to define a gap formed by the undercut contour to be formed. The additional tool can thereby be designed so that it can be used to adjust, in a defined manner and in one operation, not only the outer contour, but also the front surface, the sharp-edged transition from the front surface to the lateral surface, and the clearance. In this way, complicated undercut contours can be accurately custom-formed.

A workpiece which is produced using the method according to the invention is accordingly characterized by a continuous and uninterrupted grain flow which is substantially parallel to the formed undercut contour. Such a grain flow increases the loading capacity, lifetime and flawlessness of the material and thus workpiece quality as a whole. In addition, it takes considerably less time to produce the finished workpiece, which positively affects the cost-benefit ratio.

The workpieces that can be processed by the presented method may consist of a multiplicity of materials. For example, in the case of diesel engine pistons, steel is used for high-performance engines of commercial vehicles, whereas aluminum-silicon alloys are used for low compression ratio passenger car engines.

### BRIEF DESCRIPTION OF THE DRAWINGS

The invention will now be explained with reference to an exemplary embodiment according to FIGS. 1 to 7.

FIG. 1 schematically shows the arrangement of the components that are required by the method, wherein a steel piston is selected as the workpiece.

FIG. 2 shows a working sequence according to claim 1 on the example of a forged steel piston as the starting workpiece.

FIG. 3 shows the optional custom-forming of the outer contour by means of a driven or freely supported tool, as well as of the clearance by means of a pivotable tool.

FIG. 4 shows, as a further example, a section taken through a front-axle housing in which the outer contour to be worked is illustrated before and after the working process.

FIG. 5 shows a working sequence for forming a gas-tight cooling duct, wherein the flow of material is directed inwardly.

FIGS. 6 and 7 show further working sequences for forming a gas-tight cooling duct but with an outwardly directed flow of material.

### WAYS TO CARRY OUT THE INVENTION

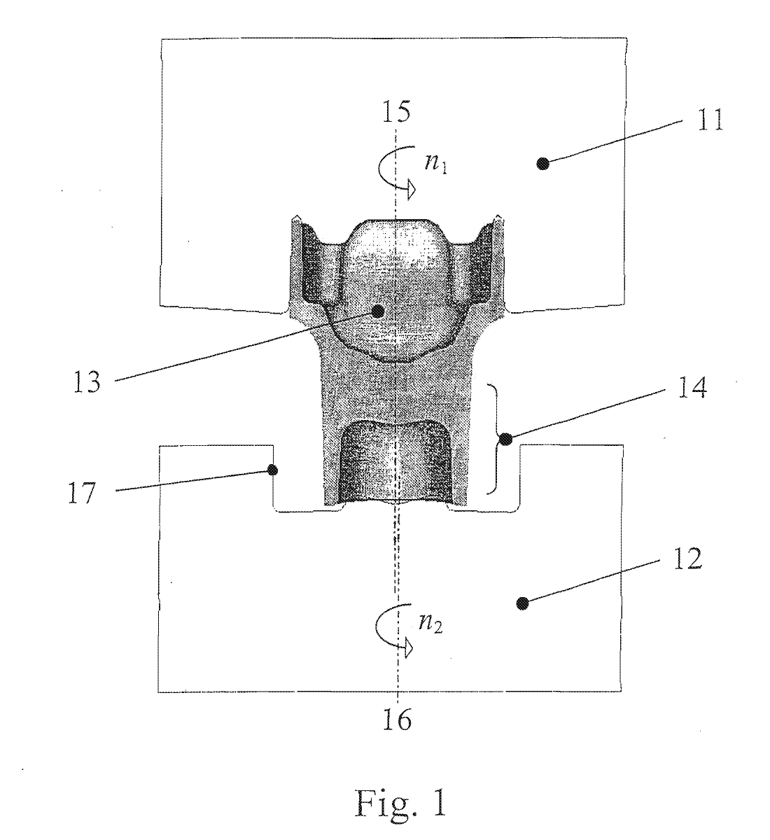

With the method illustrated in FIGS. 1 to 3, a rotationally symmetrical, undercut outer contour is formed on a forged steel piston as is used in high-performance diesel engines.

The method according to the invention is carried out by means of a device illustrated in FIG. 1, which comprises a collet 11 for clamping in a workpiece 13, a tool 12 for working the workpiece, as well as a means (not shown) for feeding the collet with the workpiece 13 to the tool 12. Here, the tool 12 comprises a circumferential rim which serves to radially confine the flow of material produced during working. The steel piston which is used in the example embodiment as workpiece 13 comprises a hollow rotationally symmetrical sub-section 14 which constitutes the end to be worked of the steel piston. The working tool 12 is abutted against this sub-section, with the axial pressure required for working being applied by means of the feed motion.

The collet 11 can be rotated, together with the clamped-in workpiece 13, about an axis of rotation 15, whilst the tool 12 is rotatable about its center axis 16. Both the collet and the tool comprise a rotary drive (not shown) which may respectively have a freewheel and whose speed can each be separately adjusted by means of a speed control.

The center axis 16 of the tool can, on the one hand, coincide with the axis of rotation 15 of the collet or can be offset therefrom in parallel (amount of eccentricity e>0).

In the first case, the friction occurring between the tool 12 and the workpiece sub-section 14 to be worked is produced solely by a difference between the peripheral speeds of tool 12 and collet 11 and is thus determined by the speed control. It is thus possible, particularly with very soft workpiece materials like aluminium, to limit this friction to a minimum in order to avoid possible loss of material that might result from excessive friction. If, however, harder materials like steel are used, reduced friction between the tool 12 and the workpiece sub-section 14 to be worked is often desirable in order to achieve a limitation of the resulting forces and moments. It is possible for this purpose to adjust the offset between the axes of rotation of workpiece and tool, i.e. the amount of eccentricity.

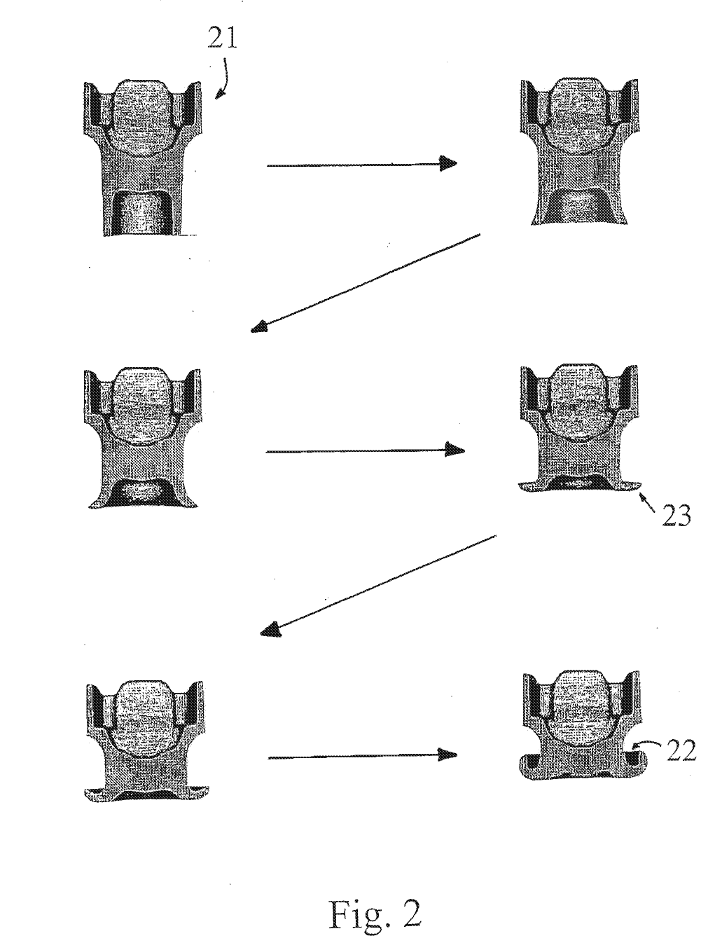

FIG. 2 shows an example of a working sequence in which a cooling duct 22 is formed as an undercut outer contour on a forged steel piston 21. The piston, clamped in the collet, is driven for this purpose with its temperature distribution determined by the forging process, i.e. substantially with its forging temperature, with a speed of, for example, n₁=1000 min⁻¹. The tool is likewise rotated, though with an initially lower speed n₂(0)<n, for example, n₂(0)=750 min⁻¹. For the purpose of working, the piston is fed to the tool under axial pressure. In this example embodiment, the freewheel of the rotary tool drive is utilized such that the speed of the tool, nᵤ adapts itself automatically to the rotational speed of the shaped part which is formed on the contact surface of tool and workpiece. Due to the resulting uniform flow of material, a flange-like expansion 23 of the piston sub-section to be worked is first produced. With further axial feed pressure, progressive flow of material leads to a bending over/flanging of the contour and can then be confined radially by the raised edge 17 of the tool 12 so as to form the undercut outer piston contour to be achieved.

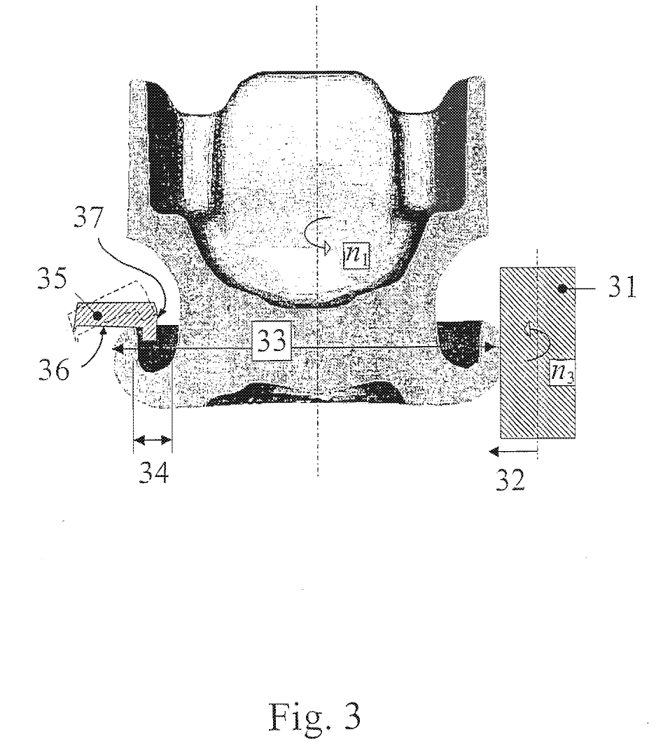

FIG. 3 shows two further working measures which serve to better define the undercut contour to be formed. In order to achieve a contour of the outer piston wall which is as dimensionally accurate as possible, an additional tool 31, which has a cylindrical design here, is fed under radial pressure to the lateral surface of the newly formed outer contour by a feeding mechanism 32 and thus confines the radially outwardly directed flow of material produced during working. As a result, the outer diameter 33 of the newly formed outer contour is brought to the requisite value. To control the friction between the tool and the outer piston contour, the additional tool may either be freely supported or driven with a speed n₃ of, for example, 750 min⁻¹.

The clearance 34 of the cooling duct can furthermore be custom-formed using a pivotable tool 35. This tool is designed to be L-shaped, with the long arm 36 abutting against the surface axially opposite to the feeding direction of the bent-over, undercut contour. The short arm 37, on the other hand, engages the gap from the outside and lies on the radially inwardly facing surface of the bent-over, undercut contour. In this manner, the pivotable tool 35 confines, if necessary, the flow of material both radially inwardly and axially against the feeding direction of the piston collet. By means of a combination of the tools 31 and 35 it is thus possible to form a cooling duct on a piston in a dimensionally accurate manner, with and without machining allowance.

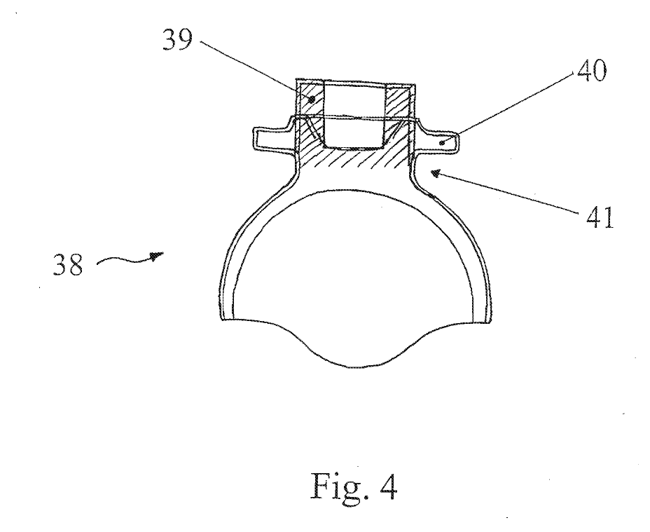

As a further example, FIG. 4 shows a section through a front-axle housing 38 on which the sub-section to be worked is illustrated before 39 and after 40 the working step. With the method according to the invention, the outer contour, which was cylindrical prior to working, was shaped into the desired, outwardly orientated outer contour with undercut section 41.

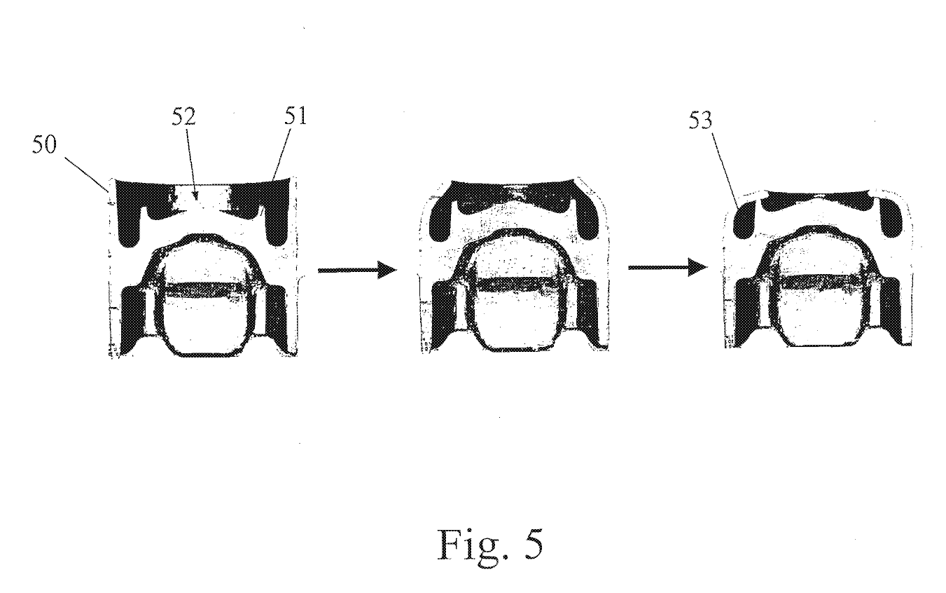

FIG. 5 illustrates an example of a working sequence of a steel piston in which the flow of material is inwardly orientated. In this case, the rotationally symmetrical sub-section 50 to be worked of the piston is bent over inwardly, step by step, by the method until it comes into contact with the edge 51 of the combustion bowl 52 and thus forms a closed, gas-tight cooling duct 53.

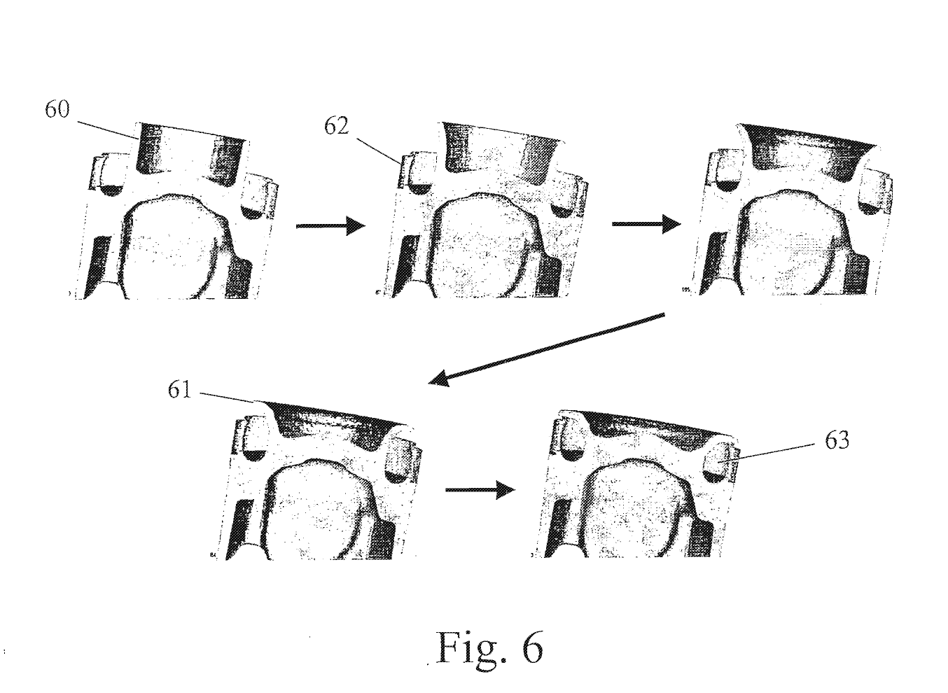

Furthermore, a gas-tight cooling duct can also be formed on a piston using an outwardly directed flow of material for working, as is shown in the working sequence of FIG. 6. In this case, a separate ring support 62 is fitted in the outer contour of the piston that terminates the cooling duct radially outwardly. Due to the method according to the invention, the sub-section 60 of the piston, which is at first cylindrical, is reshaped into a flange-like expansion 61. This ultimately comes to rest, in an axial direction, with its side facing the piston on the ring support 62, by means of which expansion 61 and ring support 62 form the gas-tight cooling duct 63.

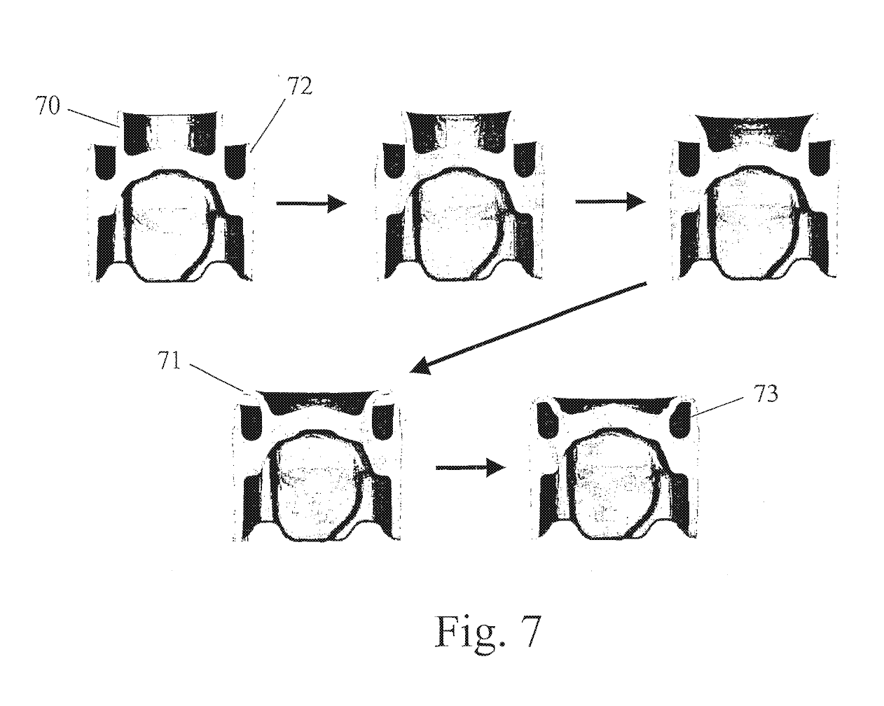

It is moreover also possible to form a gas-tight cooling duct without a ring support, using an outwardly directed flow of material, as is shown, in the end, in FIG. 7. Here, the flow of material of the sub-section 70 to be worked is again first expanded (expansion 71) and then rolled against a preformed outer contour 72 of the piston so as to form the gas-tight cooling duct 73.

The method which is disclosed in the following patent claims makes it possible to produce rotationally symmetrical, undercut contours on forged, cast or otherwise produced pistons by chipless working. Further advantageous embodiments which equally lie within the scope of this invention will, without any doubt, be apparent to those skilled in the art from the example given here.

1. A method for producing substantially rotationally symmetrical, undercut cooling ducts on a piston for internal combustion engines,
which piston has at least one sub-section to be worked with a substantially symmetrical initial contour and an axis of rotation, wherein said sub-section can be designed to be solid, partly solid or hollow,
said method comprising the following steps:
(A) clamping the piston at its first end portion not to be worked into a collet;
(B) moving towards one another the piston with collet relative to a tool;
(C) abutting the tool, which rotates at a constant or variable speed with respect to the piston, against the second, substantially symmetrical end portion of the piston; and
(D) chipless production of an undercut cooling duct by working the second end portion.

2. The method according to claim 1, wherein the moving towards one another of step B is a feed motion.

3. The method according to claim 1, wherein the undercut cooling duct to be formed in step D may be inwardly or outwardly orientated in a substantially rotationally symmetrical manner with respect to the initial contour of the piston sub-section to be worked.

4. The method according to claim 1, wherein the tool used in steps C and D has a symmetrical or asymmetrical tool contour.

5. The method according to one of claims 1 to 4, wherein in step D the tool rotates with a first speed and the piston rotates with a second speed that can be selected to be different from the first speed.

6. The method according to claim 5, wherein the first and/or the second speed is variable.

7. The method according to one of claims 1 to 6, wherein in steps C and D the axis of rotation of the substantially symmetrical piston section to be worked and the center axis of the tool are aligned.

8. The method according to one of claims 1 to 6, wherein in steps C and D the axis of rotation of the substantially symmetrical piston section to be worked and the center axis of the tool deviate by an amount of eccentricity e.

9. The method according to claim 8, wherein the amount of eccentricity can be adjusted in that the rotating tool rotates in an axially oscillating manner about the center axis of the piston section to be worked.

10. The method according to one of claims 1 to 9, wherein the entire piston is subjected, with a temperature distribution determined based on preliminary processes, to step A of the method, or is heated, in a step preceding step A, in full or in part in the piston section to be worked.

11. The method according to one of claims 1 to 10, wherein the geometry of the undercut, particularly the length of the formed undercut and the clearance, is adjustable in that the sub-section to be worked has a defined temperature distribution.

12. The method according to one of claims 1 to 11, further comprising the following step:
(E) pressing one or more loose or driven tools in a radial direction against the cooling duct being formed in order to define its outer contour.

13. The method according to one of claims 1 to 12, further comprising the following step:
(F) applying an additional tool to define a gap formed by a cooling duct to be formed, wherein the additional tool is designed so that it can be used to adjust, in a defined manner and in one operation, not only the outer contour, but also the front surface, the sharp-edged transition from the front surface to the lateral surface, and the clearance.

14. A piston produced with the method according to one of claims 1 to 13, characterized in that it comprises continuous and uninterrupted grains that are substantially parallel to the formed cooling duct.
